(19) United States
(12) Patent Application Publication
(10) Pub. No.: US 2017/0176841 A1
(43) Pub. Date: Jun. 22, 2017

(54) CAMERA RIG APPARATUS FOR SHOOTING MULTI-VIEW IMAGE

(71) Applicant: Electronics and Telecommunications Research Institute, Daejeon (KR)

(72) Inventor: Sang Won GHYME, Daejeon (KR)

(21) Appl. No.: 15/286,967

(22) Filed: Oct. 6, 2016

(30) Foreign Application Priority Data
Dec. 17, 2015 (KR) 10-2015-0181013

(51) Int. Cl. G03B 17/56; F16M 11/20; G03B 35/08

(52) U.S. Cl. CPC G03B 17/561; G03B 35/08; F16M 11/2085

(57) ABSTRACT

The present invention relates to a camera rig apparatus for shooting a multi-view image. The camera rig apparatus includes: a plurality of supporting unit in which a camera is coupled to one area, a plurality of camera fixing units which is coupled to the plurality of cameras and is coupled to corresponding supporting units to fix the cameras; a position adjusting unit which is coupled to a front side and a rear side of the plurality of supporting units and varies a horizontal distance between the plurality of supporting units; and a control unit which controls the horizontal distance of the position adjusting unit, and the position adjusting unit is formed by a lazy tongs mechanism.

### CROSS-REFERENCE TO RELATED APPLICATIONS

This application claims priority to and the benefit of Korean Patent Application No. 10-2015-0181013 filed in the Korean Intellectual Property Office on Dec. 17, 2015, the entire contents of which are incorporated herein by reference.

### TECHNICAL FIELD

The present invention relates to a camera rig apparatus for shooting a multi-view image.

### BACKGROUND ART

Generally, in order to shoot a multi-view image, two or more cameras are fixed to a rig apparatus and the rig apparatus is adjusted to control a position between cameras.

Further, in order to shoot a stereoscopic image, all cameras need to be located at a constant distance from a subject and the cameras need to be disposed at the same interval.

In this case, the interval between cameras needs to vary in accordance with the distance between the camera and the subject. For example, when a subject in a short distance is shot, the interval between cameras needs to be adjusted to be narrow. In contrast, when a subject at a long distance is shot, the interval between cameras needs to be adjusted to be wide.

However, a rig apparatus of the related art needs to control a position for every camera. Therefore, whenever the subject is changed, the interval between the cameras needs to be adjusted, and this is inconvenient. Further, when the number of cameras is increased, all the rig apparatuses corresponding to each camera need to be adjusted, so that it takes lots of time to adjust the rig apparatuses.

### SUMMARY OF THE DISCLOSURE

The present invention has been made in an effort to provide a camera rig apparatus for shooting a multi-view image which is capable of easily and quickly obtaining a multi-view image by collectively adjusting intervals of individual cameras using a lazy tongs mechanism of a camera rig apparatus in which a plurality of cameras is fixed to shoot a multi-view image.

Technical objects of the present invention are not limited to the aforementioned technical objects and other technical objects which are not mentioned will be apparently appreciated by those skilled in the art from the following description.

An exemplary embodiment of the present invention provides a camera rig apparatus for shooting a multi-view image, including: a plurality of supporting units in which a camera is coupled to one area; a plurality of camera fixing units which is coupled to the plurality of cameras, respectively and is coupled to corresponding supporting units to fix the cameras; a position adjusting unit which is coupled to a front side and a rear side of the plurality of supporting units, respectively and varies a horizontal distance between the plurality of supporting units; and a control unit which controls the horizontal distance of the position adjusting unit.

The position adjusting unit may be formed by a lazy tongs mechanism.

The plurality of supporting units may be coupled to the position adjusting unit while being spaced apart from each other in a horizontal direction with a constant interval.

The position adjusting unit may include: a first position adjusting unit which is coupled to the front side of the plurality of supporting units; a second position adjusting unit which is coupled to the rear side of the plurality of supporting units.

In this case, a position adjusting means which varies the horizontal distances of the first position adjusting unit and the second position adjusting unit using a rotational movement may be provided at one ends of the first position adjusting unit and the second position adjusting unit.

The control unit may determine the horizontal lengths of the first position adjusting unit and the second position adjusting unit and calculate a rotation amount corresponding to the determined length to control an operation of the position adjusting means.

The control unit may control the rotation amounts for the position adjusting means of the first position adjusting unit and the position adjusting means of the second position adjusting unit to be equal.

The control unit may control the rotation amounts for the position adjusting means of the first position adjusting unit and the position adjusting means of the second position adjusting unit to be different from each other.

The control unit may control the rotation amount of each of the position adjusting means such that the horizontal length of the second position adjusting unit is longer than the horizontal length of the first position adjusting unit.

The control unit may calculate the rotation amount of the position adjusting means of the second position adjusting unit with respect to the rotation amount of the position adjusting means of the first position adjusting unit, based on a ratio of a distance from the first position adjusting unit to a subject and a distance from the second position adjusting unit to the subject.

The position adjusting means may be any one of a lever which rotates by a motor and an adjusting screw.

The supporting unit may include a first coupling means which is coupled to the camera fixing unit to which the camera is coupled; and a second coupling means which is coupled to position adjusting units at a front side and a rear side of the supporting unit.

The position adjusting unit may be formed of an elastic material.

The plurality of cameras may be coupled to an upper portion or a lower portion an inner space of the corresponding supporting unit by the camera fixing unit

According to the exemplary embodiment of the present invention, a multi-view image may be easily and quickly obtained by collectively adjusting intervals of individual cameras using a lazy tongs mechanism of a camera rig apparatus in which a plurality of cameras is fixed to shoot a multi-view image.

### BRIEF DESCRIPTION OF THE DRAWINGS

FIG. 1 is a view illustrating a configuration of a camera rig apparatus for shooting a multi-view image according to an exemplary embodiment of the present invention.

FIG. 2 is a view illustrating a structure of a position adjusting means of a camera rig apparatus for shooting a multi-view image according to another exemplary embodiment of the present invention.

FIGS. 3 to 6 are views illustrating exemplary embodiments referred to explain a camera position adjusting operation of a camera rig apparatus for shooting a multi-view image according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some embodiments of the present invention will be described in detail with reference to the accompanying drawings. When reference numerals denote components in the drawings, even though the like parts are illustrated in different drawings, it should be understood that like reference numerals refer to the same parts. In describing the embodiments of the present invention, when it is determined that the detailed description of the known configuration or function related to the present invention may obscure the understanding of embodiments of the present invention, the detailed description thereof will be omitted.

In describing components of the exemplary embodiment of the present invention, terminologies such as first, second, A, B, (a), (b), and the like may be used. However, such terminologies are used only to distinguish a component from another component but nature, a sequence or an order of the component is not limited by the terminologies. If it is not contrarily defined, all terminologies used herein including technological or scientific terms have the same meaning as those generally understood by a person with ordinary skill in the art. Terminologies which are defined in a generally used dictionary should be interpreted to have the same meaning as the meaning in the context of the related art but are not interpreted as ideal or excessively formal meaning if they are not clearly defined in the present invention.

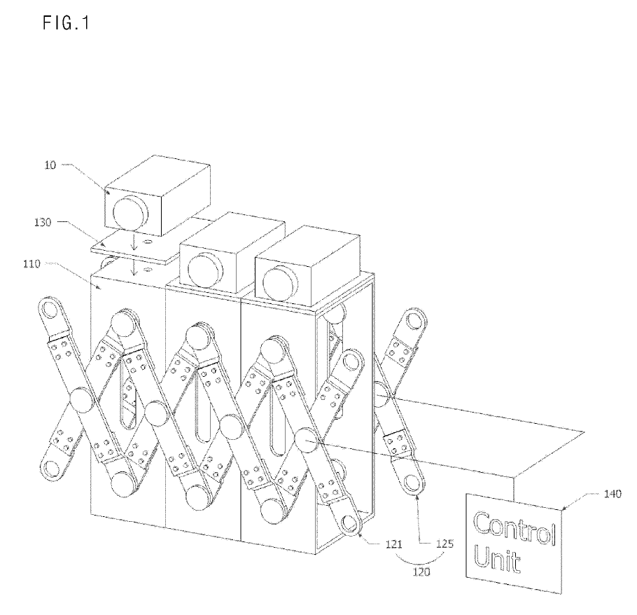

FIG. 1 is a view illustrating a configuration of a camera rig apparatus for shooting a multi-view image according to an exemplary embodiment of the present invention.

As illustrated in FIG. 1, a camera rig apparatus (hereinafter, simply referred to as a “camera rig apparatus”) for shooting a multi-view image according to an exemplary embodiment of the present invention may include a supporting unit 110, a position adjusting unit 120, a camera fixing unit 130, and a control unit 140.

The camera 10 is coupled to the camera fixing unit 130. The camera 10 which is coupled to the camera fixing unit 130 may be coupled to an upper portion or a lower portion of a corresponding supporting unit 110 by the camera fixing unit 130.

The supporting unit 110 may include a first coupling means to be coupled to the camera fixing unit 130 to which the camera 10 is fixed. As an example, the first coupling means may be implemented as a female/male protrusion. As another example, the first coupling means may be implemented as a hole into which a fixing screw (bolt) is inserted to be coupled to the camera fixing unit 130 by the fixing screw (bolt) which is inserted into the hole. However, if the first coupling means fixes the camera fixing unit 130 and the supporting unit 110, the first coupling means may be implemented by any of the shapes, but is not limited to any specific shape.

Further, the supporting unit 110 includes a second coupling means which fixes the position adjusting unit 120 to a front side and a rear side so that the supporting unit 110 may be coupled to the position adjusting unit 120 by the second coupling means. When a plurality of cameras 10 is provided, the supporting unit 110 may be provided as many as the number of cameras 10. In this case, the camera 10 is coupled to the same position of each of the plurality of supporting units.

The plurality of supporting units 110 may be coupled to the position adjusting unit 120 with a determined constant interval therebetween.

The position adjusting unit 120 may be formed by a lazy tongs mechanism. For example, the position adjusting unit 120 corresponding to one supporting unit 110 has a structure in which at least four bars are disposed in two directions which are perpendicular to each other and two bars disposed in the same direction are disposed to be parallel and regions at which two different bars intersect are axially coupled such that the position adjusting unit 120 slides around the axis. The position adjusting unit 120 corresponding to one supporting unit 110 is defined as a unit structure.

By doing this, the position adjusting units 120 corresponding to N supporting units 110 may be implemented by additionally coupling ((N−1)×2) bars to the unit structure in a horizontal direction. In this case, the position adjusting unit 120 forms a space in which N rhombus shapes are arranged in a horizontal direction by the ((N−1)×2) bars.

In this case, the position adjusting unit 120 is extendable in a horizontal direction by the rotational movement of the position adjusting means provided in an axial coupling region at one end.

In the meantime, the position adjusting unit 120 may include a first position adjusting unit 121 which is coupled to a front side of the supporting unit 110 and a second position adjusting unit 125 which is coupled to a rear side of the supporting unit 110.

The position adjusting means are provided at one ends of the first position adjusting unit 121 and the second position adjusting unit 125. The position adjusting means is connected to the control unit 140. Therefore, the position adjusting means rotates in one direction by a control operation of the control unit 140. Here, the position adjusting means may be any one of a lever which rotates by a motor and an adjusting screw.

The control unit 140 may control the rotation amount of the position adjusting means of the first position adjusting unit 121 and the position adjusting means of the second position adjusting unit 125 to be equal. In this case, the first position adjusting unit 121 and the second position adjusting unit 125 may be extendable (extend or be reduced) by the same length. Therefore, as the lengths of the first position adjusting unit 121 and the second position adjusting unit 125 are adjusted, intervals of the supporting units 110 which are coupled to the first position adjusting unit 121 and the second position adjusting unit 125 may be collectively adjusted.

As an example, when an image at a long distance is shot by the camera 10, the control unit 140 controls the rotation amounts of the position adjusting means of the first position adjusting unit 121 and the position adjusting means of the second position adjusting unit 125 to be equal in one direction so that the first position adjusting unit 121 and the second position adjusting unit 125 extend by the same length. In this case, the intervals of the supporting units 110 which are coupled to the first position adjusting unit 121 and the second position adjusting unit 125 may collectively extend.

As another example, when an image at a short distance is shot by the camera 10, the control unit 140 controls the rotation amounts of the position adjusting means of the first position adjusting unit 121 and the position adjusting means of the second position adjusting unit 125 to be equal in different directions so that the first position adjusting unit 121 and the second position adjusting unit 125 are reduced by the same length. In this case, the intervals of the supporting units 110 which are coupled to the first position adjusting unit 121 and the second position adjusting unit 125 may be collectively reduced.

In the meantime, the control unit 140 may control the rotation amounts of the position adjusting means of the first position adjusting unit 121 and the position adjusting means of the second position adjusting unit 125 to be different from each other.

As an example, when the lengths of the first position adjusting unit 121 and the second position adjusting unit 125 extend, the control unit 140 may control the rotation amount of the position adjusting means of the second position adjusting unit 125 to be more than the rotation amount of the position adjusting means of the first position adjusting unit 121.

In this case, the second position adjusting unit 120 extends so that the length of the second position adjusting unit 120 is longer than the length of the first position adjusting unit 121. Therefore, the supporting unit 110 which is coupled to the first position adjusting unit 121 and the second position adjusting unit 125 is inwardly curved. Similarly, as the lengths of the first position adjusting unit 121 and the second position adjusting unit 125 are adjusted, intervals of the supporting units 110 which are coupled to the first position adjusting unit 121 and the second position adjusting unit 125 may be collectively adjusted.

Here, the first position adjusting unit 121 and the second position adjusting unit 125 may be formed of an elastic material.

As described above, as the lengths of the first position adjusting unit 121 and the second position adjusting unit 125 are adjusted, the intervals of the supporting units 110 are collectively adjusted. Therefore, the intervals between cameras 10 coupled to the upper portion or the lower portion of the supporting unit 110 may be collectively adjusted.

In the meantime, even though not illustrated in FIG. 1, the camera rig apparatus according to the exemplary embodiment of the present invention may further include a storing unit (not illustrated) which stores data and a program required for the operation.

In the storing unit of the camera rig apparatus, an algorithm by which the control unit 140 calculates a rotation amount of the position adjusting means of the position adjusting unit 120 may be stored and a control condition may be stored.

Here, the storing unit may include at least one storage medium of a random access memory (RAM), a static random access memory (SRAM), a read-only memory (ROM), a programmable read-only memory (PROM), and an electrically erasable programmable read-only memory (EEPROM).

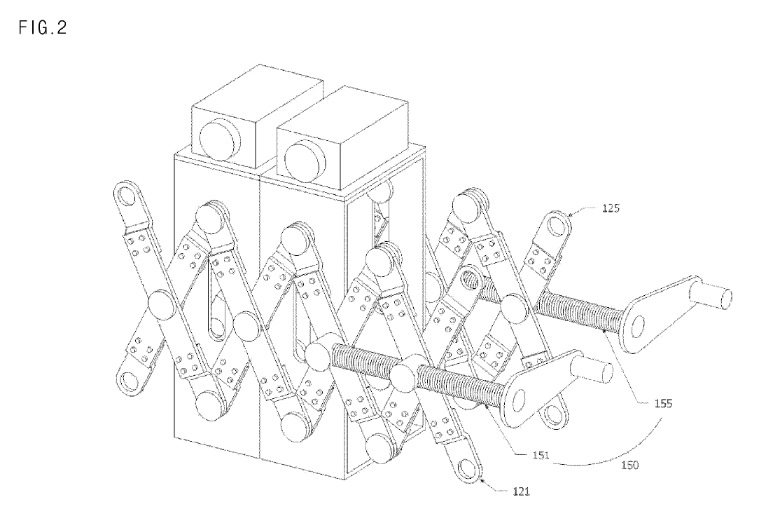

FIG. 2 is a view illustrating a structure of a position adjusting means of a camera rig apparatus for shooting a multi-view image according to another exemplary embodiment of the present invention.

As illustrated in FIG. 2, the position adjusting means 150 may be implemented as adjusting screws 151 and 155.

The adjusting screws 151 and 155 are provided in first position adjusting unit 121 and the second position adjusting unit 125, respectively, to rotate the first position adjusting unit 121 and the second position adjusting unit 125 in one direction by the control operation of the control unit 140.

In this case, the control unit 140 controls the rotation amounts of the adjusting screws provided in the first position adjusting unit 121 and the second position adjusting unit 125 to be equal so that the first position adjusting unit 121 and the second position adjusting unit 125 are extendable (extend or be reduced) by the same length.

In the meantime, the control unit 140 controls the rotation amounts of the adjusting screws provided in the first position adjusting unit 121 and the second position adjusting unit 125 to be different from each other so that the first position adjusting unit 121 and the second position adjusting unit 125 is inwardly curved.

In the meantime, a rotatable handle is disposed at one ends of the adjusting screws 151 and 155 to be manually manipulated by a user.

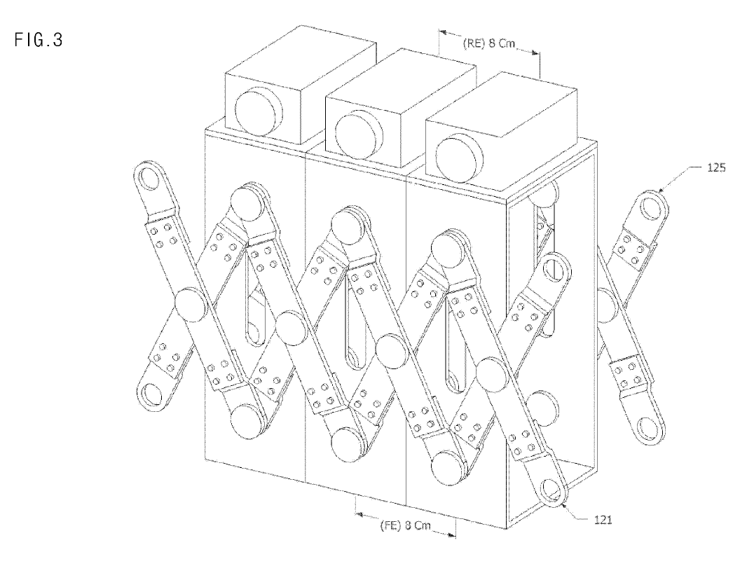

FIGS. 3 to 5 are views illustrating exemplary embodiments referred to explain a camera position adjusting operation of a camera rig apparatus for shooting a multi-view image according to an exemplary embodiment of the present invention.

First, FIG. 3 illustrates a camera position adjusting operation according to a first exemplary embodiment. According to the first exemplary embodiment, the first position adjusting unit 121 which is coupled to a front side of the supporting unit and the second position adjusting unit 125 which is coupled to a rear side are adjusted such that an interval between unit structures of the position adjusting unit is 8 cm.

Referring to FIG. 3, a rotating position adjusting means is mounted at one ends of the first position adjusting unit 121 and the second position adjusting unit 125. The control unit controls a rotation amount of each of the position adjusting means to adjust the distance between the unit structures of the first position adjusting unit 121 and the second position adjusting unit 125.

Here, the control unit determines a distance between unit structures which are coupled to the supporting units of the first position adjusting unit 121 and the second position adjusting unit 125 and calculates a rotation amount corresponding to the determined distance value to control the position adjusting means of the first position adjusting unit 121 and the second position adjusting unit 125.

In the first exemplary embodiment, the distance between unit structures of the first position adjusting unit 121 and the second position adjusting unit 125 is controlled to be 10 cm. Here, since the intervals between the unit structures of the first position adjusting unit 121 and the second position adjusting unit 125 are equal, that is, 10 cm, the control unit controls the rotation amounts of the position adjusting means of the first position adjusting unit 121 and the second position adjusting unit 125 to be equal.

By doing this, the distances between cameras are also collectively adjusted to be 10 cm.

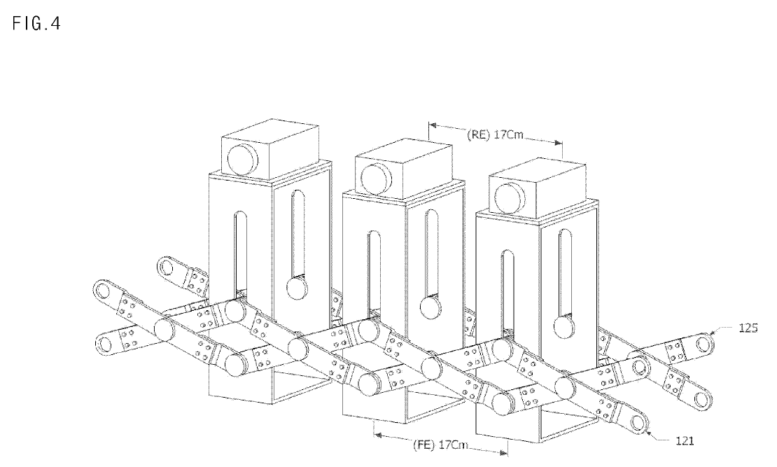

FIG. 4 illustrates a camera position adjusting operation according to a second exemplary embodiment. According to the second exemplary embodiment, the first position adjusting unit 121 and the second position adjusting unit 125 are adjusted such that a distance between unit structures of the position adjusting unit is 17 cm.

Similarly to the first exemplary embodiment illustrated in FIG. 3, in the second exemplary embodiment, since the distances between the unit structures of the first position adjusting unit 121 and the second position adjusting unit 125 are equal, so that the control unit controls the rotation amounts of the first position adjusting unit 121 and the second position adjusting unit 125 to be equal.

However, in the second exemplary embodiment, the distance between the unit structures of the first position adjusting unit 121 and the second position adjusting unit 125 is 17 cm, which is longer than the distance between the unit structures in the first exemplary embodiment. Therefore, the rotation amounts of the position adjusting means of the first position adjusting unit 121 and the second position adjusting unit 125 are increased as compared with the first exemplary embodiment.

By doing this, the distances between cameras are also collectively adjusted to be 17 cm.

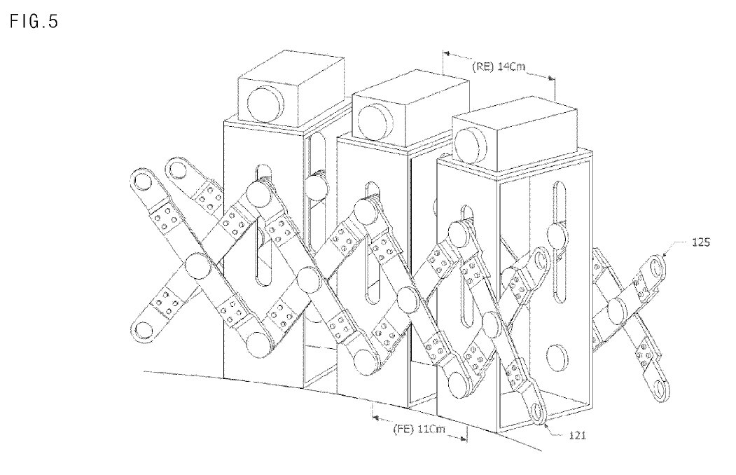

In the meantime, FIG. 5 illustrates a camera position adjusting operation according to a third exemplary embodiment. According to the third exemplary embodiment, the first position adjusting unit 121 which is coupled to a front side of the supporting unit and the second position adjusting unit 125 which is coupled to a rear side are adjusted to be different from each other.

Referring to FIG. 5, in the third exemplary embodiment, differently from the first and second exemplary embodiments, the distance between the unit structures of the first position adjusting unit 121 is different from the distance between the unit structures of the second position adjusting unit 125.

Therefore, the control unit controls the rotation amounts of the position adjusting means of the first position adjusting unit 121 and the position adjusting means of the second position adjusting unit 125 to be different from each other so as to adjust the distance between the unit structures of the first position adjusting unit 121 and the distance between the unit structures of the second position adjusting unit 125 to be different from each other.

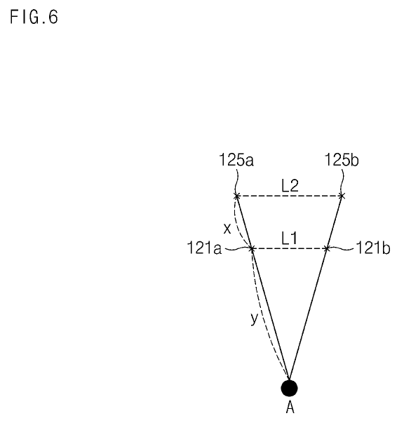

Here, a ratio of the distance between the unit structures of the first position adjusting unit 121 and the distance between the unit structures of the second position adjusting unit 125 may be calculated by referring to an exemplary embodiment of FIG. 6.

As illustrated in FIG. 6, when it is assumed that the distance between the unit structures of the first position adjusting unit 121 and the unit structures of the second position adjusting unit 125 is x and a distance from the unit structure of the first position adjusting unit 121 to a subject A is y, a ratio of an adjusted distance L1 of the unit structures of the first position adjusting unit 121 and an adjusted distance L2 of the unit structures of the second position adjusting unit 125 may be defined by L1:L2=y: (x+y). Therefore, when L1 is assumed to be 1, L2 may be calculated by ((x+y)/y).

Therefore, as illustrated in FIG. 5, when the distance L1 between the unit structures of the first position adjusting unit 121 is adjusted to be 11 cm, the control unit 140 may adjust the distance L2 between the unit structures of the second position adjusting unit 125 to be “((x+y)/y)×11”.

In this case, the distance L2 between the unit structures of the second position adjusting unit 125 is longer than the distance L1 between the unit structures of the first position adjusting unit 121, so that the first position adjusting unit 121 and the second position adjusting unit 125 may be inwardly curved.

As described above, the camera rig apparatus for shooting a multi-view image according to the exemplary embodiment of the present invention collectively may control the distance between a plurality of cameras only by adjusting the distance between unit structures of the position adjusting unit, so that convenience of manipulation for shooting a multi-view image may be increased.

It will be appreciated that various exemplary embodiments of the present invention have been described herein for purposes of illustration, and that various modifications, changes, and substitutions may be made by those skilled in the art without departing from the scope and spirit of the present invention.

Therefore, the exemplary embodiments of the present invention are provided for illustrative purposes only but not intended to limit the technical spirit of the present invention. The scope of the technical concept of the present invention is not limited thereto. The protective scope of the present invention should be construed based on the following claims, and all the technical concepts in the equivalent scope thereof should be construed as falling within the scope of the present invention.

What is claimed is:

1. A camera rig apparatus for shooting a multi-view image, comprising:
a plurality of supporting unit in which a camera is coupled to one area;
a plurality of camera fixing units which is coupled to the plurality of cameras and is coupled to corresponding supporting units to fix the cameras;
a position adjusting unit which is coupled to a front side and a rear side of the plurality of supporting units and varies a horizontal distance between the plurality of supporting units; and
a control unit which controls the horizontal distance of the position adjusting unit,
wherein the position adjusting unit is formed by a lazy tongs mechanism.

2. The camera rig apparatus of claim 1, wherein the plurality of supporting units is coupled to the position adjusting unit while being spaced apart from each other in a horizontal direction with a constant interval.

3. The camera rig apparatus of claim 1, wherein the position estimating unit includes:
a first position adjusting unit which is coupled to the front side of the plurality of supporting units; and
a second position adjusting unit which is coupled to the rear side of the plurality of supporting units, and
a position adjusting means which varies the horizontal distances of the first position adjusting unit and the second position adjusting unit using a rotational movement is provided at one ends of the first position adjusting unit and the second position adjusting unit.

4. The camera rig apparatus of claim 3, wherein the control unit determines the horizontal lengths of the first position adjusting unit and the second position adjusting unit and calculates a rotation amount corresponding to the determined length to control an operation of the position adjusting means.

5. The camera rig apparatus of claim 4, wherein the control unit controls the rotation amounts for the position adjusting means of the first position adjusting unit and the position adjusting means of the second position adjusting unit to be equal.

6. The camera rig apparatus of claim 4, wherein the control unit controls the rotation amounts for the position adjusting means of the first position adjusting unit and the position adjusting means of the second position adjusting unit to be different from each other.

7. The camera rig apparatus of claim 6, wherein the control unit controls the rotation amount of each of the position adjusting means such that the horizontal length of the second position adjusting unit is longer than the horizontal length of the first position adjusting unit.

8. The camera rig apparatus of claim 6, wherein the control unit calculates the rotation amount of the position adjusting means of the second position adjusting unit with respect to the rotation amount of the position adjusting means of the first position adjusting unit, based on a ratio of a distance from the first position adjusting unit to a subject and a distance from the second position adjusting unit to the subject.

9. The camera rig apparatus of claim 3, wherein the position adjusting means is any one of a lever which rotates by a motor and an adjusting screw.

10. The camera rig apparatus of claim 1, wherein the supporting unit includes:
a first coupling means which is coupled to the camera fixing unit to which the camera is coupled; and
a second coupling means which is coupled to position adjusting units at a front side and a rear side of the supporting unit.

11. The camera rig apparatus of claim 1, wherein the position adjusting unit is formed of an elastic material.

12. The camera rig apparatus of claim 1, wherein the plurality of cameras is coupled to an upper portion or a lower portion of the corresponding supporting unit by the camera fixing unit.
